(19) United States
(12) Patent Application Publication
(10) Pub. No.: US 2025/0234909 A1
(43) Pub. Date: Jul. 24, 2025

(54) FREEZE-DRIED, GROUND CHILI PEPPERS

(71) Applicant: Lane D. Grado, Albuquerque, NM (US)

(72) Inventor: Lane D. Grado, Albuquerque, NM (US)

(21) Appl. No.: 19/034,295

(22) Filed: Jan. 22, 2025

Related U.S. Application Data
(60) Provisional application No. 63/624,514, filed on Jan. 24, 2024.

(51) Int. Cl. A23L 27/14; A23B 7/024; A23L 5/10

(52) U.S. Cl. CPC A23L 27/14; A23B 7/024; A23L 5/10

(57) ABSTRACT

A chili powder is produced by freeze drying fresh chile peppers, and the grinding the dried peppers to a fine mesh. The peppers may be roasted, skinned, and de-seeded before freeze drying. The powder has a floral bouquet, a fruity flavor, and enhances vibrant color, compared to conventionally prepared chili powder. The powder is heated and/or irradiated to kill pathogens before being eaten.

### CROSS REFERENCE TO RELATED APPLICATIONS

This application claims priority under 35 U.S.C. § 119 to provisional patent application U.S. Ser. No. 63/624,514, filed Jan. 24, 2024. The provisional patent application is herein incorporated by reference in its entirety, including without limitation, the specification, claims, and abstract, as well as any figures, tables, appendices, or drawings thereof.

### TECHNICAL FIELD

The present disclosure relates generally to freeze dried chili peppers and a corresponding method of use/manufacture the freeze dried chili peppers.

### BACKGROUND

Chile peppers are used for cooking with many different types of foods. The peppers may be fresh, frozen, dehydrated, canned or freeze-dried. The peppers may be sliced, diced, whole or powdered. Many varieties of peppers can be used, including red and green.

Different peppers have different flavors, depending upon the climate and soils in the regions they are grown. Some chile varieties have been developed to offer different specific features, such as heat levels from very mild to extra hot. Different chiles varieties have unique flavor profiles, making them desirable for home cooking, restaurants, and professional chefs. Fresh chiles have a limited shelf life, similar to other fresh vegetables. Freezing or freeze-drying the chiles extends the shelf life much longer.

Chiles can be processed in many ways, including roasting, freezing, freeze-drying, canning, dehydrating, air drying, or grinding into powders. Roasting peppers allows the skins to be removed, if desired. Roasting of peppers may be done in tumbling bins, on barbecue grills, and in ovens. After roasting, the skins of the chiles peppers may be stripped and seeds removed. Another option is to steam the peppers to remove the skins. Then the peppers may be portioned, such as slicing, dicing, or chopping. While fresh peppers are available for a short period after the peppers are harvested during harvest season from approximately mid-July to early November (before the first freeze), frozen chiles are readily available year-round. Commercially packaged frozen chiles are sold in vacuum-sealed bags. Canning the chile peppers produces chile with degraded taste and texture, and requires addition of chemicals for preservation. Canned chiles typically have a soft texture without the firmness of freshly roasted chiles.

Peppers from the Southwest United States are typically harvested from mid-summer to late fall.

The most famous are New Mexico chiles, which are grown in the Hatch Valley in southern New Mexico. These chiles have a superior flavor that is highly desired and sought after. New Mexico chiles are approximately 90%+water content. The fresh chiles can be air dried or mechanically dried to reduce the water down to around 10%, so that the dry chiles can be stored without refrigeration or preserving chemicals. Drying the chiles tends to darken the color significantly and may change the taste to be somewhat bitter. Thus, drying changes the flavor profile, compared to a fresh fully ripened chile, which has natural sweetness.

Freeze-dried chiles may be rehydrated to become similar to freshly roasted chiles, with superior flavor and texture compared to other preservation techniques. Prior art New Mexico chile powders have been made from fresh chiles that have been air dried, dehydrated, or mechanically dried, and then ground into powders. These drying techniques change the color and flavor of the chiles.

Prior to 2020 freeze-dried Hatch chiles were unavailable and unheard of, even at New Mexico specialty chiles stores, the New Mexico Department of Agriculture, located only an hour from the Hatch chiles fields, or at the Chile Pepper Institute at New Mexico State University, which is an international non-profit research organization specializing in education and archiving chile pepper information. Even a world renowned, famous author of more than 30 books about chiles had never seen or heard of freeze-dried Hatch chiles. Both natural and mechanical drying of chiles for preservation has been well known, as has freeze-drying of other types of food products, but freeze-drying whole or chopped New Mexico chiles is a relatively new process.

### SUMMARY

The present invention is directed toward roasted, freeze-dried, and powdered chile peppers. Preliminary roasting of the chile peppers imparts a different and distinct flavor profile, compared to the fresh, dried chiles. Freeze-drying the roasted peppers retains the colors, flavors, and nutritional profiles of the chiles. Grinding freeze-dried chiles produces a powder with a brighter color and a completely different flavor profile than conventional chile powders, for both red and green peppers. Powders made from roasted and then freeze-dried, chiles deliver a significantly different end product compared to powders made through traditional drying processes. For example, this process produces chili powder with a more floral bouquet, and a fruity or fruit forward flavor with a hint of natural sweetness. These characteristics are not present in conventionally produced chili powders. This new powder opens the door to many new and exciting food and recipe applications.

Another variation of the process is to produce the powder from freeze dried fresh chiles. In this alternative embodiment, the fresh, unroasted chili is sliced open and then freeze dried. The dried product still includes skin and seeds. After freeze drying, the sliced product is ground to a fine powder, in the range of 80 mesh or finer, which mixes the tiny skin pieces with the flesh or pulp material, so as to “hide” the skin pieces, which otherwise have an unpleasant feel in a consumer's mouth.

### BRIEF DESCRIPTION OF THE DRAWINGS

FIG. 1 is a flow diagram showing one preferred embodiment of the process of the present invention.

FIG. 2 is a schematic flow chart illustrating a second embodiment of the process of the invention.

### DETAILED DESCRIPTION

The chile powders of the present invention begins by harvesting chile peppers, then washing the harvested peppers, and then roasting the peppers in a spiral roaster for at least 3-5 minutes until the exterior pepper temperature is in the range of 165° F. The heated peppers are then rinsed with tap water and transferred to sanitized baskets or buckets. After the rinse water drains from the peppers, the peppers are diced and spread onto sanitized stainless-steel trays for freezing. The trays of frozen chiles peppers are then placed into a freeze dryer for 24-72 hours. The resulting freeze-dried peppers can then be ground into a powder, preferably between 20-320 mesh size. Freshly roasted peppers can be rinsed, portioned and then placed directly into a freeze dryer if desired, skipping the pre-freezing step in the process. In addition, peppers that have been previously roasted and then frozen can be thawed out and then portioned into trays and freeze dried.

The roasting time and flame temperature can vary. Also, the freeze-drying cycle can range from 24-72 hours.

In the freeze-drying process, the distributed “wet” chiles placed in the freeze dryer are chilled to approximately −40° F. The chiles are then slowly warmed over several hours, during which the water content is transformed from ice crystals directly to gas, with a vacuum pump removing the moisture from the air. The warming temperature typically ranges from 125-175° F. The freeze-drying time depends on the equipment, the moisture content of the chiles in that batch, the warming cycle temperatures, and the temperature of the chiles when they are placed in the freeze dryer. Pre-frozen chiles will have a shorter freeze-dry cycle time than chiles that start at room temperature.

The typical yield of freeze-dried chiles from wet to powder is approximately 4.5-5.5%. Thus, 100 pounds of “wet” chiles yields approximate 4.5-5.5 pounds of freeze-dried chile. powder. In comparison, dehydrated chiles have approximately 8-12% residual moisture content. Dehydrated chiles, either through natural air drying or mechanical drying, is typically used for making traditional green and red chiles powders.

In one embodiment of the invention, the chile peppers are harvested, preferably locally, such that freezing is not required. The harvested chiles are roasted for at least 3-5 minutes to reach a surface temperature of preferably 165° F. or more. The chiles may then be cleaned using water jets to remove seeds and skins. The cleaned chiles may be left whole or may be chopped and diced into smaller pieces. The chiles, with or without the skins and seeds, are then placed onto sanitized trays and placed into freeze dryers for 24-72 hours. The freeze dried chiles are then ground into powder, or alternatively, packaged for storage and later ground into powder. Preferably, the powder size is 20-320 mesh, and preferably in the range of 40-80 mesh. The powdered chiles are then heated to 165° or irradiated to kill all pathogens, such that the powder is ready for safe consumption.

In the roasting process, chiles are placed in a round metal cage, with flame jets firing into the cage as the cage is rotated such that the chiles tumble over one another. After several minutes, the chiles skins turn black and blister from the heat. Then, water jets can be sprayed through the cage under the chiles to remove most of the skin and seeds, if desired. The skin can also be removed with other processes, such as blanching or boiling the chili and then plunging the chili into a water bath. Other skin removal processes include blackening/charring/blistering the skins in or on a skillet, comal, or other similar pan or pot. As another alternative, the skins and seeds can be retained, in which case they mix with the chile pepper flesh when ground so as to be imperceptible in the final powder product. Chiles are then removed from the cage for the next stage of processing. In one alternative to a rotating cage, the chiles may be roasted on a moving conveyor belt.

In another embodiment, the harvested chiles are freeze-dried, without roasting, and then ground to a powder, including seeds, skins, stems.

The processes of the present invention can be used for many types of chiles, including New Mexico chiles, Anaheim chiles, Poblano chiles, Pueblo chiles from Colorado, and other green or red chiles, which can be harvested year-round. The inventive processes can also be used for making powder from other types of peppers, such as bell peppers. The process can be used for chiles and peppers that are fully ripened, un-ripened, or partially ripened. In other words, the un-ripened green fruit may be used, or the fruit may be at different ripening stages where the color is yellow, orange, or red.

If the chiles are freeze-dried whole, they may then be later diced, or sliced, prior to grinding.

After freeze-drying, the moisture content of the chiles is less than 6%, and preferably less than 3%.

The seeds, stems, and skins of the chiles may be retained for grinding into powder.

The freeze-drying of the chiles preserves the natural flavor, color, and nutritional values, as compared to chiles that have been air dried, dehydrated or mechanically dried.

Nutritional values of the chile powder produced by the inventive process are higher than for other chile powders made without roasting and freeze drying. This is especially true in regard to preservation of vitamin C and other vitamins. The freeze-dried powder has an extremely high level of vitamin C, compared to traditional chile powder which has little, if any vitamin C.

Before the freeze-dried powder is consumed, it should be heated to at least 165° F. to kill all pathogens, and thus be safe to eat. An additional or alternative safety step is to irradiate the powder, which makes it “ready to eat.” Appropriate labeling of the powder packaging is highly desirable.

The freeze dried chile powder has unique colors, flavors, and bouquet which make it broadly useful in many applications, beyond traditionally manufactured chili powder. The floral bouquet and the fruity, sweet flavor make the freeze-dried powder an excellent choice for spicing up various foods, including meats and vegetables.

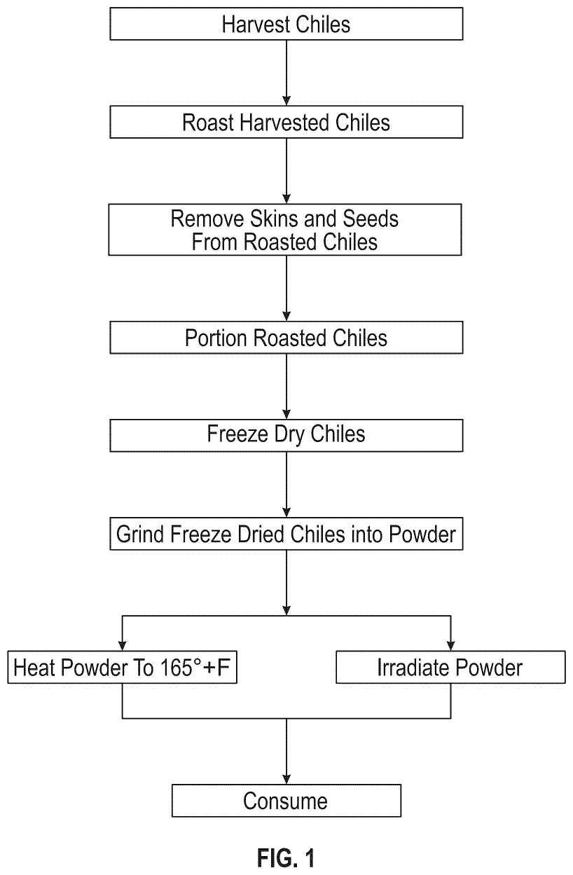

FIG. 1 schematically shows the preferred steps for making freeze dried chile powder, in accordance with the present invention. The first step is to harvest the chilis. Then, the chiles are roasted, followed by removal of the skin and seeds. The chilis are then portioned to smaller pieces, such as by slicing, dicing or cutting by any convenient means. After portioning, the chiles are freeze dried, and then ground into a powder of between 40 mesh and 120 mesh, with a desired mesh, preferably 80 or smaller. The powdered chili pepper is then heated to at least 165° or irradiated to kill bacteria. An additional or optional step of irradiating the powder may also be used to kill organisms that could potentially spoil the powder.

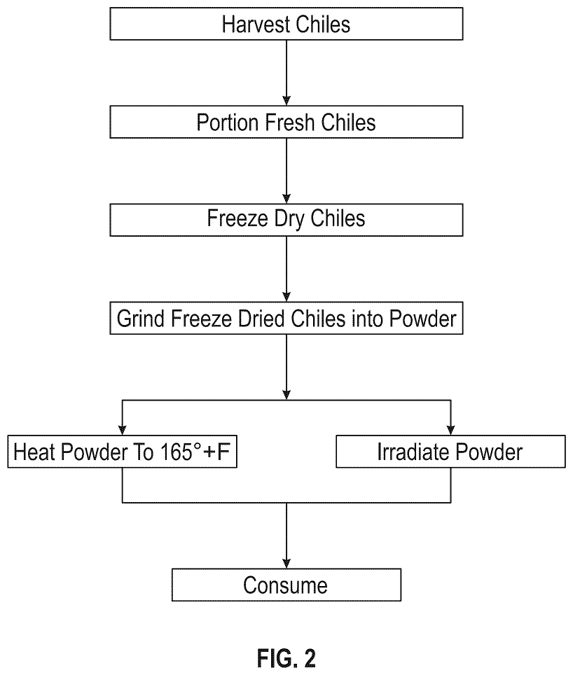

An alternative embodiment of the invention is shown in FIG. 2, and involves the same steps of harvesting, portioning, freeze drying, and grinding of the chili peppers, but eliminates the steps of roasting, skinning, and de-seeding the peppers. The unroasted, freeze-dried fresh powder produced a different flavor profile from the process of FIG. 1 and from traditionally prepared powders.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, sub combinations, or the like that would be obvious to those skilled in the art.

What is claimed is:

1. A method for making chile powder, comprising:
washing chile peppers to clean the chile peppers; then
roasting the cleaned chile peppers; then
freeze drying the roasted chile peppers; and then
grinding the freeze dried chile peppers into a powder.

2. The method of claim 1 wherein the powdered chile peppers have a mesh size ranging between 20-320 mesh.

3. The method of claim 1 wherein the roasted chiles are whole, chopped, diced, or sliced before freeze drying.

4. The method of claim 1 wherein the chile peppers are freeze dried from either room temperature or previously frozen.

5. The method of claim 1 wherein the chile peppers are selected from a group consisting of New Mexico chiles, Anaheim chiles, poblano chiles, Pueblo chiles from Colorado and bell peppers.

6. The method of claim 1 wherein the chile peppers are freshly harvested prior to roasting.

7. The method of claim 1 wherein the chile peppers are selected from a group consisting of red, green, orange and yellow chile peppers.

8. The method of claim 1 wherein the freeze dried chile peppers have a moisture content of less than 6%.

9. The method of claim 1 wherein the chile peppers are roasted in a metal cage for at least 3-5 minutes.

10. The method of claim 1 wherein the roasting step heats the chile peppers to a surface temperature of approximately 165° F.

11. The method of claim 1 further comprising rinsing the roasted peppers to remove most of the skin from the roasted chile peppers.

12. The method of claim 1 further comprising opening the roasted peppers and removing most of the seeds from the chile peppers.

13. The method of claim 1 wherein skin and seeds of the chile peppers are retained.

14. A spice product, comprising:
chile peppers roasted, freeze dried, and ground to a powder.

15. The spice product of claim 14 wherein the chile peppers are selected from a group consisting of New Mexico chiles, Anaheim chiles, poblano chiles, Pueblo chiles, and bell peppers.

16. The spice product of claim 14 wherein the powder is 20-320 mesh in size.

17. The spice product of claim 14 wherein the powder is substantially free from seeds.

18. The spice product of claim 14 wherein the powder is substantially free from skin of the chile peppers.

19. The spice product of claim 14 wherein the powder has a floral bouquet, a fruity flavor, and a vibrant color.

20. A method of making chili pepper, comprising:
opening freshly harvested chili peppers;
retaining skin, flesh and seeds of the chili peppers;
freeze drying the opened chili peppers;
grinding the dried chili peppers to a mesh size of 80 or smaller to form a powdered mixture of the skin, the seeds and the flesh.
